(19) United States
(12) Patent Application Publication
(10) Pub. No.: US 2026/0050505 A1
(43) Pub. Date: Feb. 19, 2026

(54) PROBLEM IDENTIFICATION AND RESOLUTION VIA A THREE-TIERED MECHANISM

(71) Applicant: INTERNATIONAL BUSINESS MACHINES CORPORATION, ARMONK, NY (US)

(72) Inventors: David C. Reed, Tucson, AZ (US); Ryan Arthur Bouchard, Tucson, AZ (US); Matthew Barragan, Oracle, AZ (US); Philip R. Chauvet, Tucson, AZ (US)

(21) Appl. No.: 18/803,020

(22) Filed: Aug. 13, 2024

(51) Int. Cl. G06F 11/07

(52) U.S. Cl. CPC G06F 11/079; G06F 11/0709

(57) ABSTRACT

An indication that indicates an occurrence of an error in a local computing system is received. A first-tier search comprising searching a local data store corresponding to the local computing system in an effort to determine a cause of the error is executed. In response to determining that the first-tier search is unable to determine the cause of the error, a second-tier search of a global data store is executed, wherein the second-tier search comprises searching for the error in one or more computer systems that are configured similarly to the local computing system. In response to determining that the second-tier search is unable to determine the cause of the error, a third-tier search of the global data store is executed, wherein the third-tier search comprises searching for the error in additional one or more computer systems that are not similarly configured to the local computing system.

### BACKGROUND

Embodiments relate to a method, system, and computer program product for problem identification and resolution via a three-tiered mechanism.

A variety of mechanisms are used to detect the reasons for errors that occur in a computer system. In certain situations, databases, and artificial intelligence (AI) techniques are used to determine the reasons for such errors. Root cause analysis for determining the cause of the errors may be employed in certain situations. Once the cause of an error is determined, mechanisms may be used to resolve the error in the computer system.

The AI-based techniques may rely on training data from a number of support cases. Databases may of course to searched to determine the reason for the errors and the mechanisms to correct the errors. Such techniques may be applied in a networked environment and in cloud computing systems.

### SUMMARY

Provided are a method, system, and computer program product in which an indication that indicates an occurrence of an error in a local computing system is received. A first-tier search comprising searching a local data store corresponding to the local computing system in an effort to determine a cause of the error is executed. In response to determining that the first-tier search is unable to determine the cause of the error, a second-tier search of a global data store is executed, wherein the second-tier search comprises searching for the error in one or more computer systems that are configured similarly to the local computing system. In response to determining that the second-tier search is unable to determine the cause of the error, a third-tier search of the global data store is executed, wherein the third-tier search comprises searching for the error in additional one or more computer systems that are not similarly configured to the local computing system.

In additional embodiments, operations comprise cataloging, in the local data store, locally encountered problems and incidents determined over time in the local computing system, wherein the indication is provided by a symptom string that is cross-referenced in the first-tier search with information previously stored in the local data store.

In yet additional embodiments, if no matching symptom string is found in the local data store in the first-tier search, the second-tier search is performed, wherein data of the one or more computer systems that are configured similarly to the local computing system has been anonymized for the second-tier search and maintained in the global data store.

In further embodiments, the global data store includes all known issues related to the error, and is used in the third-tier search, if the second-tier search is unable to determine a matching symptom string in anonymized data of the one or more computer systems that are similarly configured to the local computing system.

In yet further embodiments, a clustering mechanism is employed in the third-tier search in the global data store to determine most similar matches to the error.

In certain embodiments, the global data store is shared for both the second-tier search and the third-tier search, but is not used in the first-tier search.

In further embodiments, local issues are prioritized for determining the cause of the error over other issues that are not local, wherein issues in computer systems more similar to the local computing system are considered for determining the cause of the error prior to considering issues in other computing systems.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a block diagram that shows a tiered problem analysis mechanism, in accordance with certain embodiments.

FIG. 3 illustrates a block diagram that shows an overview of a tiered error resolution system, in accordance with certain embodiments.

FIG. 4 illustrates a block diagram that shows a tiered error resolution system, in accordance with certain embodiments.

FIG. 5 illustrates a flow chart that shows exemplary operations, in accordance with certain embodiments.

FIG. 6 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Users in a client environment may experience a wide range of issues on their systems. The range of issues may range from system outages, data loss, severe performance problems, and other impactful events. The costs for these events go up as the duration during which a system is having such issues increases.

The quicker the cause and solution for such an event can be identified, the less of an impact these events have. A methodology is needed to automatically identify the root cause of an issue and the recovery steps that may be needed for a particular client environment.

Certain embodiments provide an approach where historical data is organized in a three-tier format. The first tier is data specific to the individual business. The second tier is data from other businesses with similar configurations. The third and final tier is global data across all clients on this operating system platform. Utilizing the data in such a way provides a method where the most relevant cause and solution may be found by searching for the symptom strings first in the first tier, then in the second tier, and finally in the third tier. The solution corresponding to that symptom string will then have a higher probability of being the correct resolution. This is especially true in those situations where clients frequently see the same error due to missing maintenance on a system, an error in their program, poor system configuration, or excessive or unbalanced workload to name a few problem types often seen in a particular environment. Furthermore, clients with similar configurations are more likely to encounter the same problem than those with different configurations.

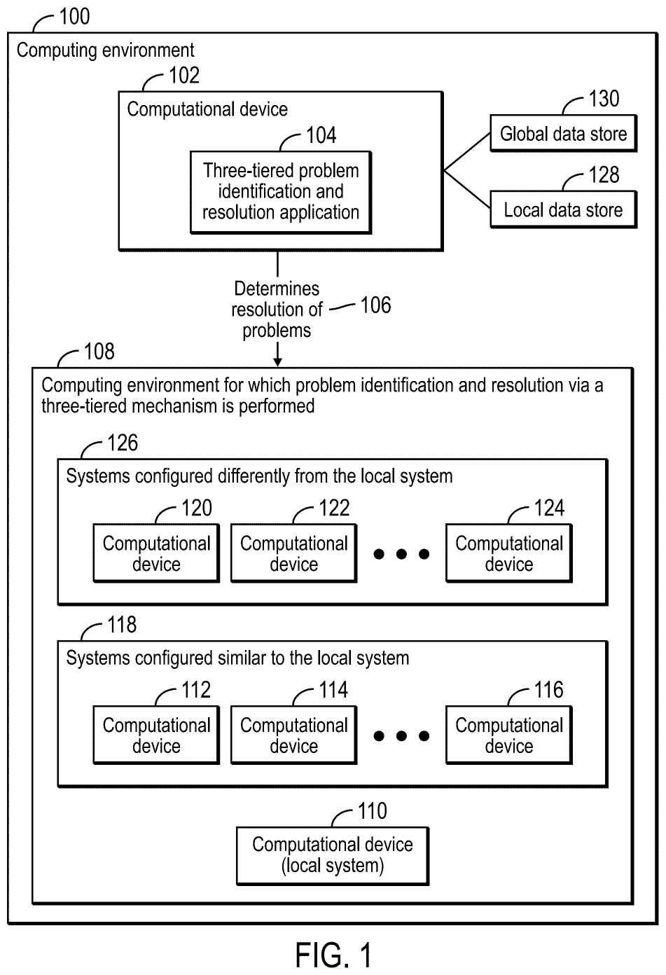

FIG. 1 illustrates a block diagram of a computing environment 100, in accordance with certain embodiments.

A computational device 102 that executes a three-tiered problem identification and resolution application 104 is shown in FIG. 1. The computational device 102 determines resolution of problems (as shown via reference numeral 106) in a computing environment 108, in particular in a local system 110 within the computing environment 108.

The computing environment 108 in which problem identification and resolution is performed by the computational device 102 is comprised of a computational device 110 that is referred to as a local system, where an error occurs in the local system 110, and the cause of the error has to be detected and a resolution performed for the error. The computing environment 108, in addition to the local system 110, includes many other computational devices. Certain computational devices 112, 114, 116 are configured similarly to the local system 110 and are shown via reference numeral 118. Other computational devices 120, 122, 124 are configured differently from the local system and are shown via reference numeral 126.

A local data store 128 and a global data store 130 are used by the three-tiered problem identification and resolution application 104 that executes in the computation device 102 is included in the computing environment 100. The local data store 128 catalogs locally encountered problems and incidents determined over time in the local system 110 (also referred to as a local computing system), wherein an indication of an error in the local system 108 is provided by a symptom string that is cross-referenced in a first-tier search performed via the three-tiered problem identification and resolution application 104 with information previously stored in the local data store 128. The global data store 130 includes all known issues related to errors as determined in systems 118, 126, and is used both in a second tier and a third-tier search by the three-tiered problem identification and resolution application 104.

The computational devices including local system 110, computing device 102, and the computing devices in systems 118, 126 may in certain embodiments comprise any suitable computational device known in the art such as a server, a personal computer, a laptop, a mainframe, etc. In certain alternative embodiments, the three-tiered problem identification and resolution application 104 may execute in the local system 110, rather than in the computational device 102.

Therefore, FIG. 1 illustrates certain embodiments in which a three-tiered problem identification and resolution application 104 determines causes of errors and resolves errors in a local system 110 by using a local data store 128 and a global data store 130.

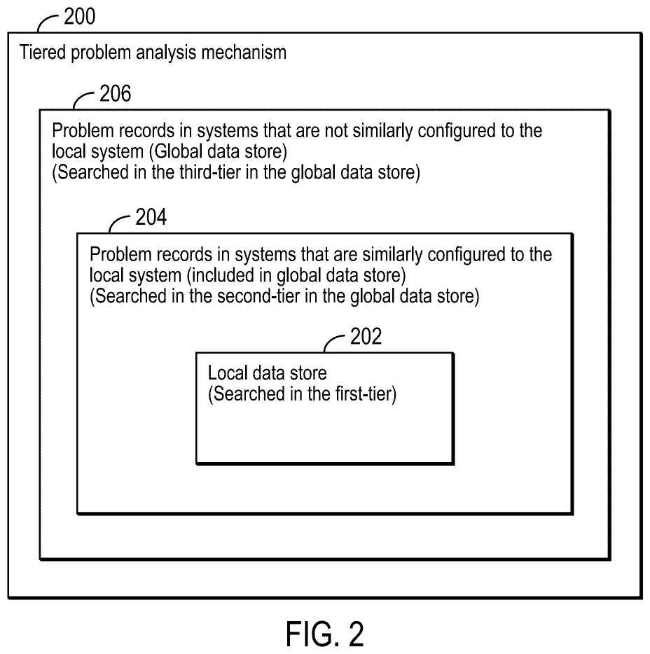

FIG. 2 illustrates a block diagram 200 that shows a tiered problem analysis mechanism, in accordance with certain embodiments.

The block shown via reference numeral 202 indicates that the local data store is searched in the first tier. The block shown via reference numeral 204 indicates that problem records in systems that are similarly configured to the local system that are included in global data store, are searched in the global data store.

The block shown via reference numeral 206 indicates that problem records in systems that are not similarly configured to the local system that are included in the global data store, are searched in the third tier in the global data store.

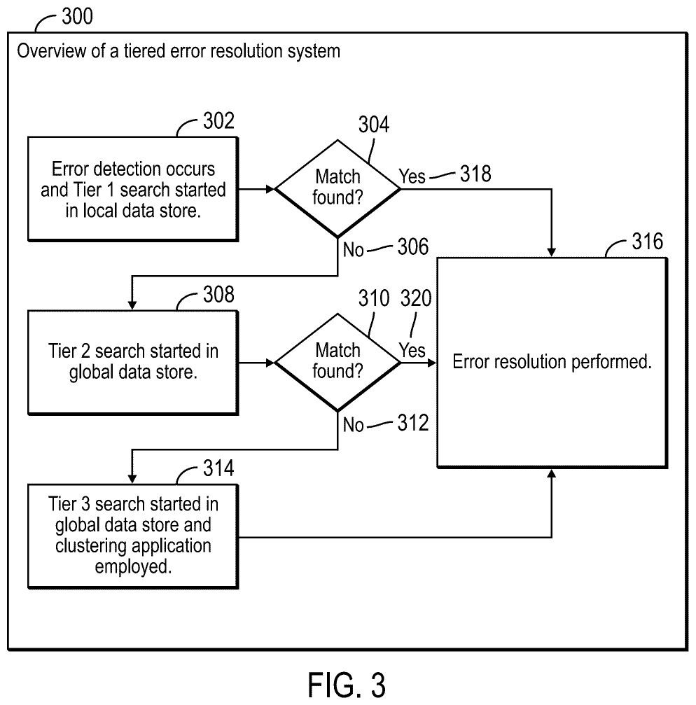

FIG. 3 illustrates a block diagram 300 that shows an overview of a tiered error resolution system, in accordance with certain embodiments. The operations shown in FIG. 3 may be performed in the computing device 102 of the computing environment 100, via the three-tiered problem identification and resolution application 104 to determine the resolution of problems.

Control starts at block 302 in which error detection occurs and tier 1 search is started in the local data store to determine whether a symptom string that denotes the error matches (at block 304) the data stored in the local data store. If not (“No” branch 306) control proceeds to block 308 in which a tier 2 search is started in the global data store.

Control proceeds to block 310 from block 308, where in block 310 it is determined whether systems that are similarly configured to the local system show a match to the symptom string. If not (“No” branch 312) control proceeds to block 314 in which a tier 3 search is started in the global data store and optionally a clustering application is employed to determine the probable cause of the error by determining data stored in the global data store from systems that are not similarly configured to the local system.

From block 314 control proceeds to block 314 where error resolution is performed. Additionally, if a match is found in either blocks 304 or 310 (“Yes” branches 318, 320) then control flows to block 316 where error resolution is performed.

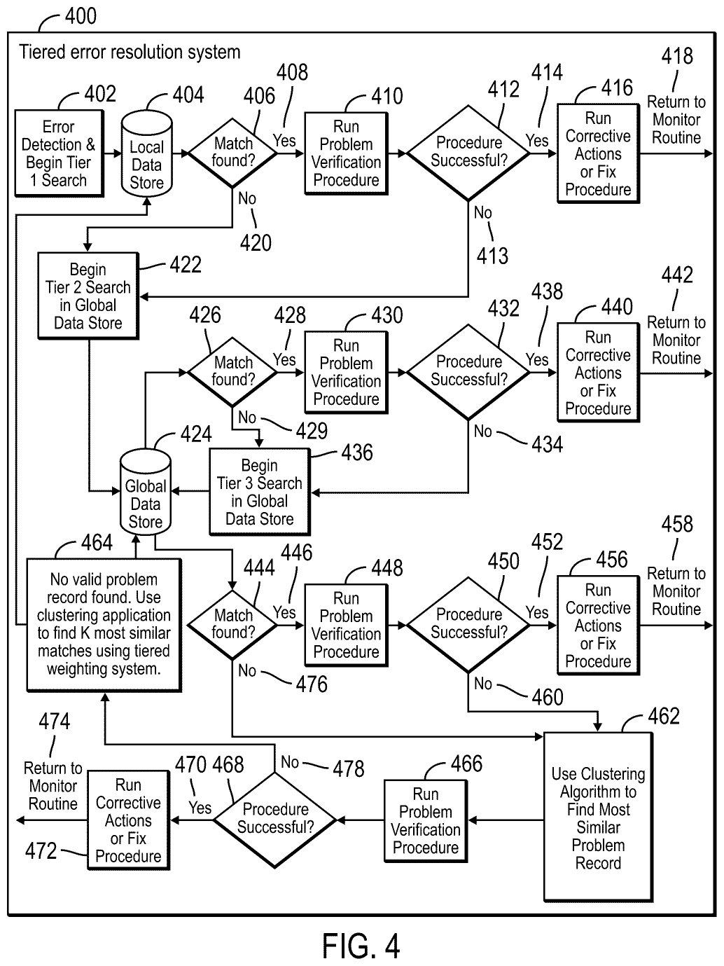

FIG. 4 illustrates a block diagram 400 that shows a tiered error resolution system, in accordance with certain embodiments. The operations shown in FIG. 4 may be performed in the computing device 102 of the computing environment 100, via the three-tiered problem identification and resolution application 104 to determine the resolution of problems.

Control starts at block 402 with error detection and a tier 1 search begins in the local data store 404 for an error. If a match is found for the error (reference numerals 406, 408) control proceeds to block 410 where a problem verification procedure is run. If the problem verification procedure is successful (reference numerals 412, 414) then corrective actions are run or the problem verification procedure is fixed (at block 416) and execution returns at block 418 to the monitor program that corresponds the three-tiered problem identification and resolution application 104. If the problem verification process is unsuccessful then control proceeds to start a tier 2 search in the global data store (reference numerals 413, 422).

If at block 406 no match is found for the error in the local data store, then tier 2 search is started in the global data store (as shown via reference numerals 420, 422, 424). If a match is found then a problem verification procedure is executed and if the problem verification procedure is not successful then tier 3 search is begun in the global data store (as shown via reference numerals 426, 428, 430, 432, 434, 436, 424). If a match is not found (as shown via “No” branch 429) in block 426 then control proceeds to block 436 to begin the three-tier search in the global data store. Thus, if a match is not found in tier 2 search or the problem verification process is unsuccessful in tier 2 search, then the tier 3 search is started.

If the problem verification procedure 432 is successful (reference numeral 438) then corrective actions are run or the problem verification procedure is fixed (at block 440) and execution returns at block 442 to the monitor program that corresponds the three-tiered problem identification and resolution application 104.

If in tier 3 search a match is found, then problem verification procedure is performed and if problem verification procedure is successful then corrective actions are performed or the procedure fixed and the process returns to the monitor routine (reference numerals 444, 446, 448, 450, 452, 456, 458).

If at block 450 the problem verification procedure is unsuccessful at tier 3 search then a clustering algorithm is used to find a most similar problem record (reference numerals 460, 462). On using the clustering algorithm to fine the most similar problem record, a problem verification procedure is run and if successful, corrective actions are taken or the procedure is fixed and the process returns to the monitor routine (reference numeral 462, 466, 468, 470, 472, 474). If no match is found in block 444 control proceeds to block 462 for using clustering algorithm to find the most similar problem record.

If the procedure is not successful at block 468 (“No” branch 478) control proceeds to block 464 that shows how the clustering is performed by finding K (K is an integer) most similar matches using a tiered weighting systems by a K-nearest neighbor algorithm (KNN algorithm that is a known clustering algorithm).

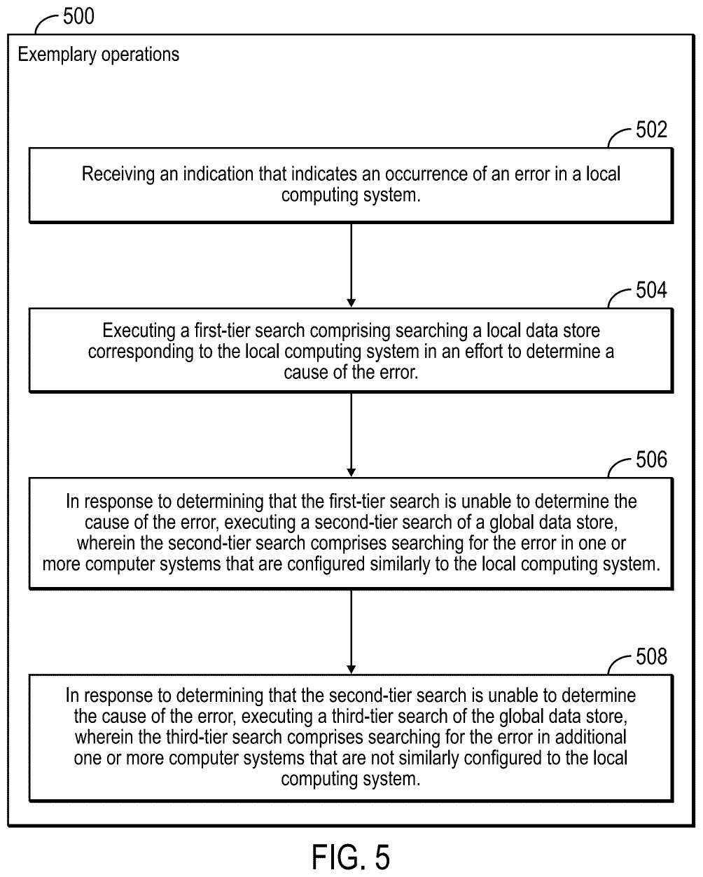

FIG. 5 illustrates a flow chart 500 that shows exemplary operations, in accordance with certain embodiments. The operations shown in FIG. 5 may be performed in the computing device 102 of the computing environment 100, via the three-tiered problem identification and resolution application 104 to determine the resolution of problems.

Control starts at block 502, in which an indication that indicates an occurrence of an error in a local computing system is received. A first-tier search comprising searching a local data store corresponding to the local computing system in an effort to determine a cause of the error is executed (at block 504).

From block 504, control proceeds to block 506 in which in response to determining that the first-tier search is unable to determine the cause of the error, a second-tier search of a global data store is executed, wherein the second-tier search comprises searching for the error in one or more computer systems that are configured similarly to the local computing system. In response to determining (at block 508) that the second-tier search is unable to determine the cause of the error, a third-tier search of the global data store is executed, wherein the third-tier search comprises searching for the error in additional one or more computer systems that are not similarly configured to the local computing system.

Therefore, FIGS. 1-5 illustrate certain embodiments for problem identification and resolution via a three-tiered mechanism. This results in an improvement in detecting and repairing errors in computing systems.

In certain embodiments, upon initialization, a process scans the system environment (such as applied maintenance levels, parmlib options, etc.) and assigns an environment classification type for the system. After initialization, a monitoring program can run in either real time or in scheduled batch processing windows. When it runs, it ingests information from various system data sources (such as syslog, logrec, etc.) and whenever it detects an error, it executes operations described below.

When an error is detected, such as a return code higher than 8, it generates a symptom string and then begins a three-tiered search. In the first tier, the program cross references the detected symptom string with a local knowledge data store, which is tasked with cataloging locally encountered problems and incidents seen on this individual business's system(s). If no matching symptom string is found, then the process begins a broader second tier search of problems and incidents encountered by systems of other businesses (whose data has been anonymized) with similar configurations within the larger global data store, and checks for a matching symptom string. Lastly, if no match is found at the previous tiers, then the final tier (third tier) searches the remaining records within the global knowledge data store, which encompasses all known issues.

The three tiers described use only two data stores: a local data store that catalogs all problems encountered locally on that business's system(s), and a global data store that catalogs all known problems. The intermediate or second tier mentioned within this disclosure is a subset of problem records with a matching environment classification type, which is determined for each system upon initialization; however, these problem records are stored entirely within the global data store. In other words, the second tier is searching the global data store, but filtering only on problem records with the same environment classification type, which is stored within the environment characteristics field in problem records.

After the initial search of the three tiers, if no symptom string is found to match exactly, then the process checks whether similar problems are instead causing the detected problem, since it is possible that a known problem is exhibiting different symptoms that have yet to be recorded within either the local or global knowledge data store. This is achieved by leveraging a clustering machine learning algorithm, such as a supervised clustering model like K-nearest neighbors (KNN), to identify a set of known issues that most closely align with the detected error.

Finally, if the problem verification procedure fails for the entire set of similar problem records, then a new record needs to be created in each searched data store tier because a newly identified problem has been encountered for the first time, and all the searched tiers in this instance will have a new record created to ensure all levels are aware of this newly identified problem. However, if a match is found and verified to be the correct root cause in either the second or final tier in the global data store, then each preceding tier needs to be updated to reflect that this particular problem has been encountered. That means if a problem record is matched and validated in the final tier of searching within the global data store, then that will be updated in the global data store record by appending the environment classification type to the environment characteristics field, and then also creating a new record in the local data store to reflect that this problem has been encountered locally. Furthermore, if a matched and validated record is instead found in the second tier, then that record is only added to the local data store (since the global data store already has knowledge of this problem occurring within this type of environment).

It is possible that a symptom string exists in multiple tiers, but once a match is found, a problem verification procedure is given to validate the match, and if the match is validated, then corrective actions are given to resolve the known issue, and the program returns since subsequent searching in the higher-level tiers is no longer needed once the problem is identified and resolved. Alternatively, if a matching symptom string's corresponding problem verification procedure is unable to validate the identified issue, then searching of subsequent tiers continues, but any duplicate record found in higher level tiers will be skipped because the verification procedure has already failed when tested in an earlier, lower-level tier. Duplicate records are identified by their problem id field, which is generated by hashing (with a collision-free hash function) the symptom string, problem verification procedure, and corrective actions.

This search order of the data store tiers ensures that certain embodiments prioritize known local issues over other problems only encountered by other systems of other businesses. Furthermore, if a problem has never been seen locally, then it also ensures that known issues for similarly configured systems are prioritized over the searching of a global data store that includes all known issues. If multiple instances of a symptom string (with differing problem verification procedures and/or corrective actions) are found in the same tier, then the symptom string from the system with the most similar configuration is given a higher weighting, and the corresponding problem verification procedure will be executed for a symptom found on a more similar system before other matching symptoms with less similar configurations within the same tier.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

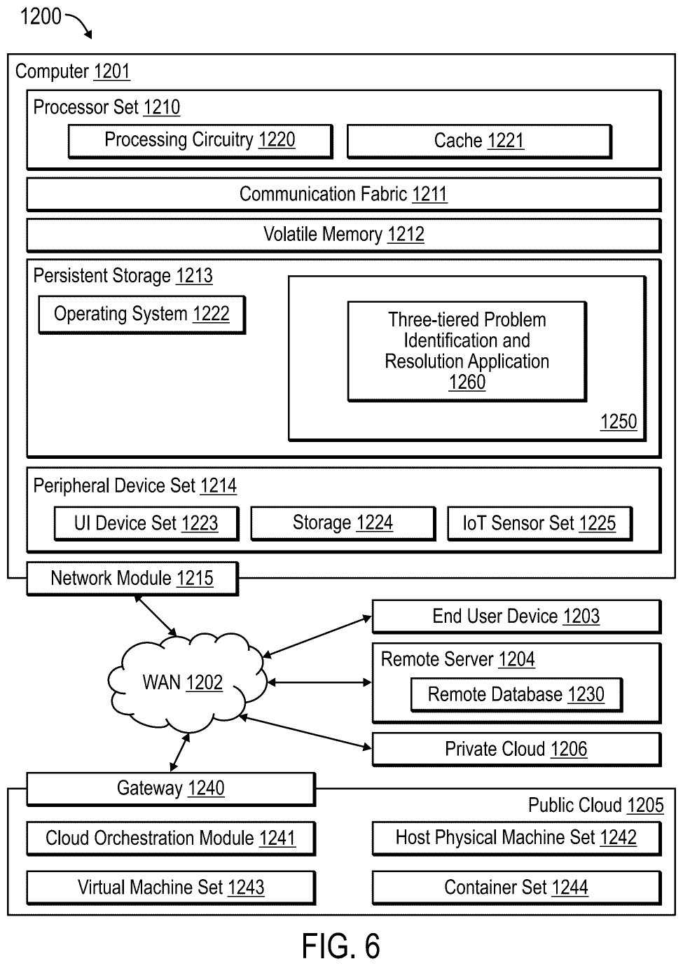

In FIG. 6, a computing environment 1200 contains an example of an environment for the execution of at least some of the computer code (block 1250) involved in performing the operations of an application for a three-tiered problem identification and resolution application 1260 that performs operations shown in FIGS. 1-5.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IOT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 6. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A method, comprising:
receiving an indication that indicates an occurrence of an error in a local computing system;
executing a first-tier search comprising searching a local data store corresponding to the local computing system in an effort to determine a cause of the error;
in response to determining that the first-tier search is unable to determine the cause of the error, executing a second-tier search of a global data store, wherein the second-tier search comprises searching for the error in one or more computer systems that are configured similarly to the local computing system;
in response to determining that the second-tier search is unable to determine the cause of the error, executing a third-tier search of the global data store, wherein the third-tier search comprises searching for the error in additional one or more computer systems that are not similarly configured to the local computing system;
in response to a problem verification procedure being successful, executing corrective actions and returning to a monitor routine; and
in response to the problem verification procedure being unsuccessful, determining via a clustering application, a predetermined number of most similar matches using a tiered weighting system.

2. The method of claim 1, the method further comprising:
cataloging, in the local data store, locally encountered problems and incidents determined over time in the local computing system, wherein the indication is provided by a symptom string that is cross-referenced in the first-tier search with information previously stored in the local data store.

3. The method of claim 2, wherein if no matching symptom string is found in the local data store in the first-tier search, the second-tier search is performed, wherein data of the one or more computer systems that are configured similarly to the local computing system has been anonymized for the second-tier search and maintained in the global data store.

4. The method of claim 3, wherein the global data store includes all known issues related to the error, and is used in the third-tier search, if the second-tier search is unable to determine a matching symptom string in anonymized data of the one or more computer systems that are similarly configured to the local computing system.

5. The method of claim 4, wherein a clustering mechanism is employed in the third-tier search in the global data store to determine most similar matches to the error.

6. The method of claim 1, wherein:
the global data store is shared for both the second-tier search and the third-tier search, but is not used in the first-tier search.

7. The method of claim 1, wherein local issues are prioritized for determining the cause of the error over other issues that are not local, and wherein issues in computer systems more similar to the local computing system are considered for determining the cause of the error prior to considering issues in other computing systems.

8. A system, comprising:
a memory; and
a processor coupled to the memory, wherein the processor performs operations, the operations comprising:
receiving an indication that indicates an occurrence of an error in a local computing system;
executing a first-tier search comprising searching a local data store corresponding to the local computing system in an effort to determine a cause of the error;
in response to determining that the first-tier search is unable to determine the cause of the error, executing a second-tier search of a global data store, wherein the second-tier search comprises searching for the error in one or more computer systems that are configured similarly to the local computing system;
in response to determining that the second-tier search is unable to determine the cause of the error, executing a third-tier search of the global data store, wherein the third-tier search comprises searching for the error in additional one or more computer systems that are not similarly configured to the local computing system;
in response to a problem verification procedure being successful, executing corrective actions and returning to a monitor routine; and
in response to the problem verification procedure being unsuccessful, determining via a clustering application, a predetermined number of most similar matches using a tiered weighting system.

9. The system of claim 8, the operations further comprising:
cataloging, in the local data store, locally encountered problems and incidents determined over time in the local computing system, wherein the indication is provided by a symptom string that is cross-referenced in the first-tier search with information previously stored in the local data store.

10. The system of claim 9, wherein if no matching symptom string is found in the local data store in the first-tier search, the second-tier search is performed, wherein data of the one or more computer systems that are configured similarly to the local computing system has been anonymized for the second-tier search and maintained in the global data store.

11. The system of claim 10, wherein the global data store includes all known issues related to the error, and is used in the third-tier search, if the second-tier search is unable to determine a matching symptom string in anonymized data of the one or more computer systems that are similarly configured to the local computing system.

12. The system of claim 11, wherein a clustering mechanism is employed in the third-tier search in the global data store to determine most similar matches to the error.

13. The system of claim 8, wherein:
the global data store is shared for both the second-tier search and the third-tier search, but is not used in the first-tier search.

14. The system of claim 8, wherein local issues are prioritized for determining the cause of the error over other issues that are not local, and wherein issues in computer systems more similar to the local computing system are considered for determining the cause of the error prior to considering issues in other computing systems.

15. A computer program product, the computer program product comprising a computer readable storage medium, wherein code stored in the computer readable storage medium when executed by a processor performs operations, the operations comprising:
receiving an indication that indicates an occurrence of an error in a local computing system;
executing a first-tier search comprising searching a local data store corresponding to the local computing system in an effort to determine a cause of the error;
in response to determining that the first-tier search is unable to determine the cause of the error, executing a second-tier search of a global data store, wherein the second-tier search comprises searching for the error in one or more computer systems that are configured similarly to the local computing system;
in response to determining that the second-tier search is unable to determine the cause of the error, executing a third-tier search of the global data store, wherein the third-tier search comprises searching for the error in additional one or more computer systems that are not similarly configured to the local computing system;
in response to a problem verification procedure being successful, executing corrective actions and returning to a monitor routine; and
in response to the problem verification procedure being unsuccessful, determining via a clustering application, a predetermined number of most similar matches using a tiered weighting system.

16. The computer program product of claim 15, the operations further comprising:
cataloging, in the local data store, locally encountered problems and incidents determined over time in the local computing system, wherein the indication is provided by a symptom string that is cross-referenced in the first-tier search with information previously stored in the local data store.

17. The computer program product of claim 16, wherein if no matching symptom string is found in the local data store in the first-tier search, the second-tier search is performed, wherein data of the one or more computer systems that are configured similarly to the local computing system has been anonymized for the second-tier search and maintained in the global data store.

18. The computer program product of claim 17, wherein the global data store includes all known issues related to the error, and is used in the third-tier search, if the second-tier search is unable to determine a matching symptom string in anonymized data of the one or more computer systems that are similarly configured to the local computing system.

19. The computer program product of claim 18, wherein a clustering mechanism is employed in the third-tier search in the global data store to determine most similar matches to the error.

20. The computer program product of claim 15, wherein:
the global data store is shared for both the second-tier search and the third-tier search, but is not used in the first-tier search.
